(19) United States
(12) Patent Application Publication
(10) Pub. No.: US 2021/0238896 A1
(43) Pub. Date: Aug. 5, 2021

(54) VEHICULAR DOOR LOCK DEVICE

(71) Applicant: AISIN SEIKI KABUSHIKI KAISHA, Kariya-shi (JP)

(72) Inventors: Naoki KAJIGAI, Kariya-shi (JP); Yasuhiko SONO, Kariya-shi (JP)

(73) Assignee: AISIN SEIKI KABUSHIKI KAISHA, Kariya-shi (JP)

(21) Appl. No.: 17/160,672

(22) Filed: Jan. 28, 2021

(30) Foreign Application Priority Data
Feb. 3, 2020 (JP) 2020-016358

(51) Int. Cl. E05B 81/06; E05B 81/30; E05B 83/36

(52) U.S. Cl. CPC E05B 81/06; E05B 81/30; E05Y 2201/702; E05Y 2201/626; E05Y 2201/704; E05B 83/36

(57) ABSTRACT

A vehicular door lock device includes: a latch mechanism switchable between latch and unlatch states; a first lever member movable to an operating position; a second lever member movable to unlock and lock corresponding positions; a link member movable to an unlock position where the latch mechanism is switchable to the unlatch state and a lock position where the latch mechanism is not switchable to the unlatch state and configured to be positioned at the unlock position when the second lever member is positioned at the unlock corresponding position and to be positioned at the lock position when the second lever member is positioned at the unlock corresponding position; and an operation member movable to initial and operation positions and configured to move the second lever member from the unlock corresponding position to the lock corresponding position by moving from the initial position to the operation position.

### CROSS REFERENCE TO RELATED APPLICATIONS

This application is based on and claims priority under 35 U.S.C. § 119 to Japanese Patent Application 2020-016358, filed on Feb. 3, 2020, the entire content of which is incorporated herein by reference.

### TECHNICAL FIELD

This disclosure relates to a vehicular door lock device.

### BACKGROUND DISCUSSION

JP 2009-13639A discloses a vehicular door lock device that enables locking by means of an operation jig in a case where locking by means of an electric drive source is impossible. Specifically, the vehicular door lock device disclosed in JP 2009-13639A has a locking/unlocking lever movable to an unlocking position and a locking position and is configured such that the locking/unlocking lever can be moved from the unlocking position to the locking position by the operation jig being inserted from an opening portion provided in a base member. With such a configuration, manual locking by means of the operation jig can be performed even in a case where locking by means of the electric drive source is impossible due to a low battery charge amount.

However, in a configuration in which a base member is provided with an opening portion as in JP 2009-13639A, foreign matter (such as rainwater and dust) may intrude into a door lock device through the opening portion and a smooth operation of the door lock device may be hindered as a result.

A need thus exists for a vehicular door lock device which is not susceptible to the drawback mentioned above.

### SUMMARY

A vehicular door lock device (20) according to an aspect of this disclosure includes: a latch mechanism (40) configured to be switchable between a latch state where a vehicle door (12) is holdable in a closed state and an unlatch state where the closed state of the vehicle door is releasable by moving from an initial position to an operating position; a first lever member (outside open lever (31)) configured to be moved to an operating position when door opening operation is performed on a door handle (inside door handle (126) or outside door handle (127)) provided on the vehicle door (12); a second lever member (active lever (25)) configured to be moved to an unlock corresponding position and a lock corresponding position by a drive force of an electric drive force source (electric motor (22)); a link member (open link (27)) movable to an unlock position where the latch mechanism (40) is switchable to the unlatch state when the first lever member (outside open lever (31)) is at the operating position and a lock position where the latch mechanism (40) is not switchable to the unlatch state even when the first lever member (outside open lever (31)) is at the operating position and configured to be positioned at the unlock position when the second lever member (active lever (25)) is positioned at the unlock corresponding position and to be positioned at the lock position when the second lever member (active lever (25)) is positioned at the unlock corresponding position; and an operation member (slide member (51)) movable to an initial position and an operation position and configured to move the second lever member (active lever (25)) from the unlock corresponding position to the lock corresponding position by moving from the initial position to the operation position.

Further, the operation member (slide member (51)) is attached to a housing (meshing portion body (45)), in which the latch mechanism (40) is assembled and an opening portion (451) is provided, so as to be movable relative to the housing (meshing portion body (45)), at least a part of the operation member (slide member (51)) is exposed to an outside from the opening portion (451), and the operation member (slide member (51)) blocks the opening portion (451) when the operation member (slide member (51)) is at the initial position.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view illustrating a configuration example of a vehicle door;

FIG. 2 is a cross-sectional view illustrating the configuration example of the vehicle door;

FIG. 3 is an exploded perspective view illustrating a configuration example of a door lock device;

FIG. 4 is a diagram illustrating the configuration example and operation of the door lock device;

FIG. 5 is a diagram illustrating the configuration example and operation of the door lock device;

FIG. 6 is a diagram illustrating the operation of the door lock device;

FIG. 7 is a diagram illustrating the operation of the door lock device;

FIG. 8 is a diagram illustrating a configuration example of a lock operation mechanism;

FIG. 9 is a cross-sectional view illustrating the configuration example and operation of the lock operation mechanism;

FIG. 10 is a cross-sectional view illustrating the configuration example and operation of the lock operation mechanism; and

FIG. 11 is a cross-sectional view illustrating the configuration example and operation of the lock operation mechanism.

### DETAILED DESCRIPTION

The vehicular door lock device according to an embodiment of this disclosure will be described below with reference to the drawings. In the following description, the vehicular door lock device according to the embodiment of this disclosure may be abbreviated as “door lock device”. In each drawing, the front of the vehicle is indicated by an arrow Fr, the rear of the vehicle is indicated by an arrow Rr, the inside of the vehicle in the vehicle width direction is indicated by an arrow In, the outside of the vehicle in the vehicle width direction is indicated by an arrow Out, the upper side is indicated by an arrow Up, and the lower side is indicated by an arrow Dw.

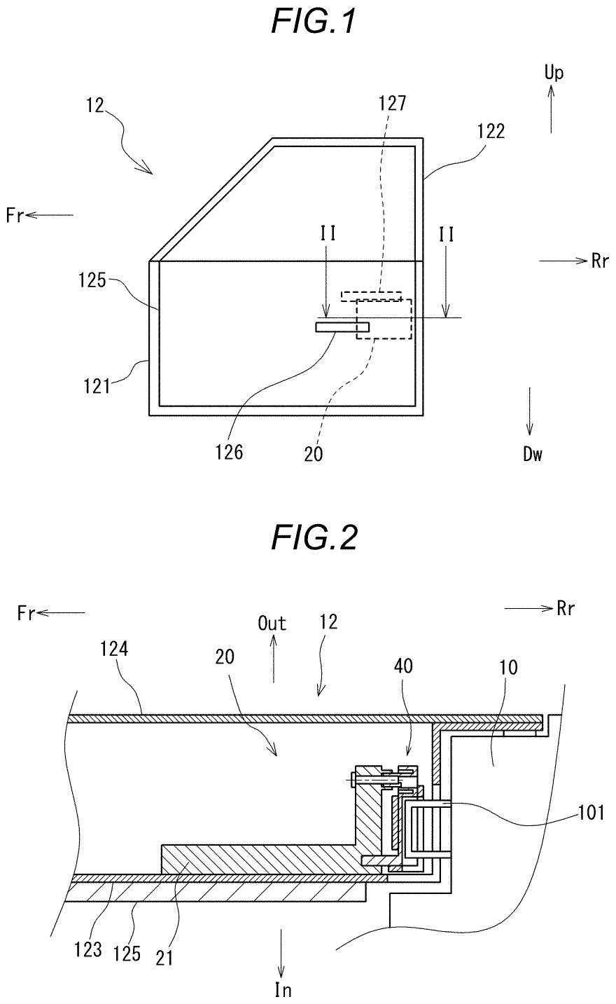

FIGS. 1 and 2 are schematic views illustrating a configuration example of a vehicle door 12 to which a door lock device 20 is applied. It should be noted that FIG. 1 is a side view of the vehicle door 12 and is a drawing viewed from the inside of the vehicle. FIG. 2 is a cross-sectional view of the vicinity of the rear end portion of the vehicle door 12 and is a cross-sectional arrow view taken along line II-II of FIG. 1. The front end portion of the vehicle door 12 is rotatably supported with respect to a vehicle body 10, and the vehicle door 12 can be opened and closed with respect to the vehicle body 10 by rotating about an axis substantially parallel to the up-down direction about the front end portion. It should be noted that each direction of the door lock device 20 in the following description is based on a case where the vehicle door 12 is closed.

As illustrated in FIG. 1, the vehicle door 12 includes a door main body portion 121 constituting the lower half portion of the vehicle door 12 and a door sash 122 provided in the upper half portion of the vehicle door 12. As illustrated in FIG. 2, the door main body portion 121 includes an outer panel 124 constituting the outside surface of the vehicle, an inner panel 123 fixed inside the outer panel 124, and a resinous trim 125 fixed to the inside surface of the inner panel 123 and constituting the inside surface of the door main body portion 121.

An outside door handle 127 is attached to the outer panel 124 so as to be rotatable with respect to the vehicle door 12, and an inside door handle 126 is attached to the trim 125 so as to be rotatable with respect to the vehicle door 12. The outside door handle 127 and the inside door handle 126 are examples of the door handle according to this disclosure. Each of the outside door handle 127 and the inside door handle 126 is capable of rotating and moving to the initial and release positions and is always urged to the initial position by urging means such as a spring. A user or the like can manually move the inside door handle 126 and the outside door handle 127 from the initial position to the release position. In the following description, the operation of moving each of the outside door handle 127 and the inside door handle 126 from the initial position to the release position will be referred to as “door opening operation”. It should be noted that the configurations of the outside door handle 127 and the inside door handle 126 are not particularly limited and various known configurations can be applied.

In the present embodiment, the vehicle door 12 has neither a lock knob for switching between the lock and unlock states of the door lock device 20 from the inside of the vehicle nor a key cylinder for switching between the lock and unlock states of the door lock device 20 from the outside of the vehicle.

As illustrated in FIG. 2, the door lock device 20 is disposed in the inner space between the inner panel 123 and the outer panel 124 of the vehicle door 12 and is fixed to the inner panel 123 (that is, the vehicle door 12). It should be noted that a part of the door lock device 20 is exposed to the outside of the vehicle door 12 in the rear end portion of the vehicle door 12.

The door lock device 20 has a latch mechanism 40 switchable between a latch state and an unlatch state. The latch state means a state where the vehicle door 12 can be held in a closed state, and the unlatch state means a state where the closed state of the vehicle door 12 can be released. The specific configuration of the latch mechanism 40 is not particularly limited, and various known configurations such as the following configuration can be applied.

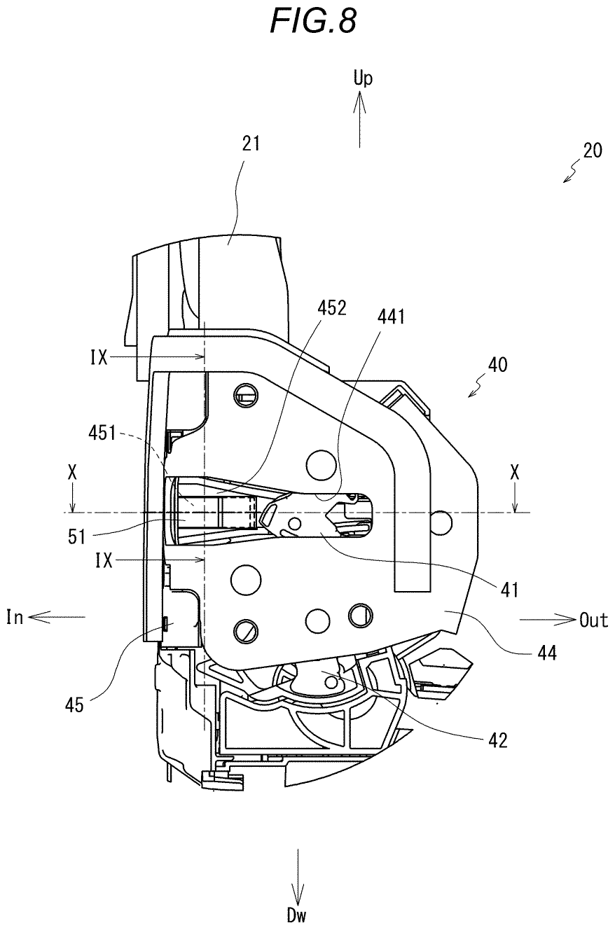

As illustrated in FIG. 8, the latch mechanism 40 is assembled to a base plate 44 formed of a metal plate and a meshing portion body 45 formed of a resin material. The meshing portion body 45 is a member that forms the housing of the door lock device 20 together with an actuator portion body 21 (described later). The latch mechanism 40 has a latch 41 and a pawl 42. The latch 41 is rotatably supported by the base plate 44 and is capable of rotating and moving to unlatch, half latch, and full latch positions. The unlatch position is a position where a striker 101 (see FIG. 2) provided on the vehicle body 10 is not held (position allowing engagement and disengagement). The half latch position and the full latch position are positions where the striker 101 is held in a case where the vehicle door 12 is in the closed state. Further, the latch 41 is always urged toward the unlatch position by a latch return spring.

The pawl 42 is rotatably supported by the base plate 44 and is capable of moving to engagement and non-engagement positions. The engagement position is a position where the latch 41 is held at the half latch position or the full latch position by engagement with the latch 41 (where rotational movement to the unlatch position is prevented). The unlatch position is a position of non-engagement with the latch 41 and is a position that allows rotational movement of the latch 41 to the unlatch position. Further, the pawl 42 is always urged toward the engagement position by a pawl return spring.

In addition, the door lock device 20 has a lift lever 43. The lift lever 43 is an example of the latch mechanism switching member according to this disclosure. The lift lever 43 is rotatably supported with respect to the base plate 44 and is capable of rotating and moving to the initial and operating positions. Further, when the lift lever 43 moves from the initial position to the operating position in a case where the vehicle door 12 is in the closed state, the lift lever 43 engages with the pawl 42 (for example, pushes the pawl 42) to move the pawl 42 from the engagement position to the non-engagement position. As a result, the engagement between the pawl 42 and the latch 41 is released, the latch 41 is rotationally moved to the unlatch position by the urging force of the latch return spring, and the closed state of the vehicle door 12 can be released.

As described above, the latch mechanism 40 may be configured to switch from the latch state to the unlatch state by the movement of the lift lever 43 in a case where the lift lever 43 moves from the initial position to the operating position.

Further, the door lock device 20 is configured to be switchable between the lock and unlock states. The lock state is a state where the latch mechanism 40 does not switch to the unlatch state because the position of the lift lever 43 is maintained at the initial position even in the event of the door opening operation on the inside door handle 126 or the outside door handle 127 (state where the closed state of the vehicle door 12 cannot be released). The unlock state is a state where the lift lever 43 moves from the initial position to the operating position and the latch mechanism 40 switches to the unlatch state as a result of the door opening operation on the inside door handle 126 or the outside door handle 127.

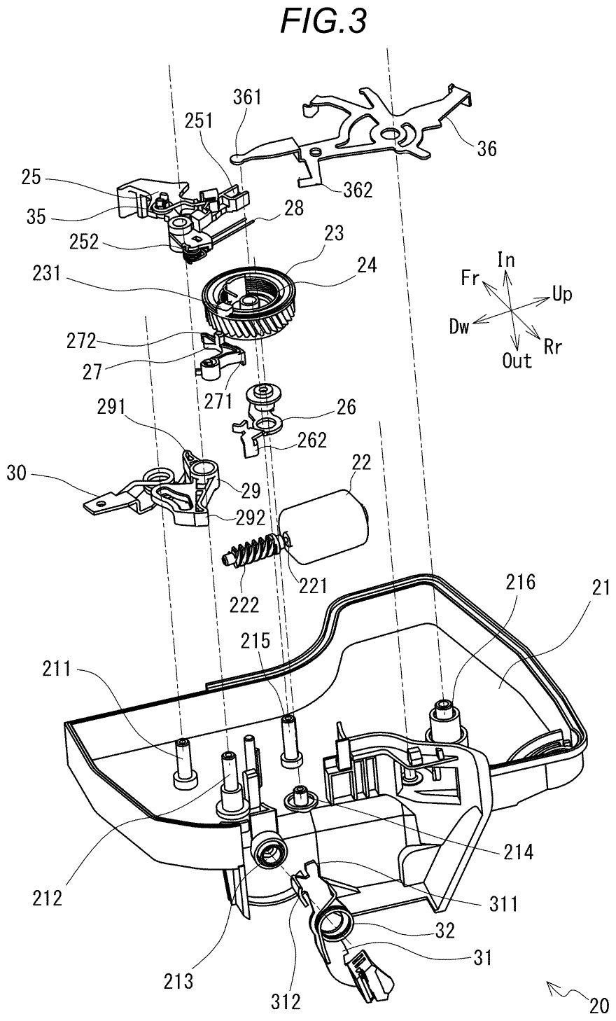

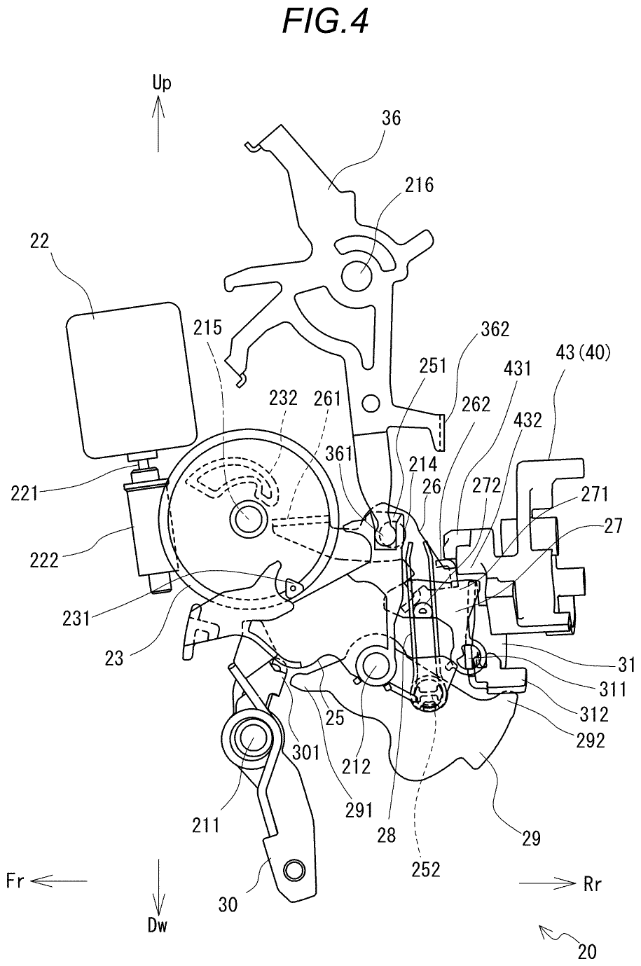

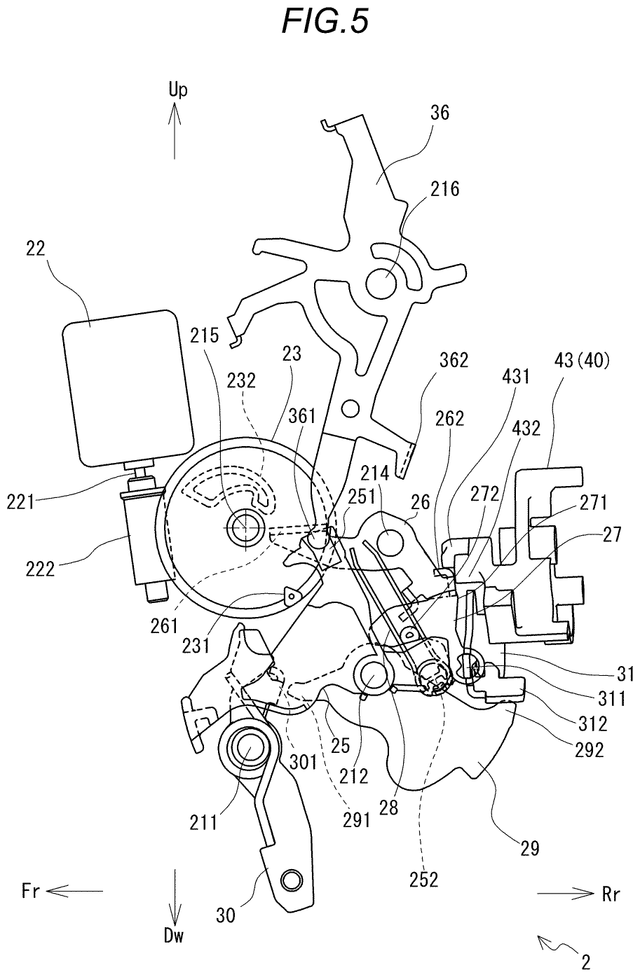

As illustrated in FIGS. 3 to 5, the door lock device 20 has the actuator portion body 21, an inside open lever 30, an inside lever 29, an outside open lever 31, an open link 27, the lift lever 43, an active lever 25, a release lever 26, a rotation member 23, an electric motor 22, and a control lever 36 in addition to the latch mechanism 40. It should be noted that FIG. 3 is an exploded perspective view illustrating a configuration example of the door lock device 20. FIG. 4 is a diagram illustrating the unlock state of the door lock device 20, and FIG. 5 is a diagram illustrating the lock state of the door lock device 20. In addition, the door lock device 20 has a lock operation mechanism 50 (see FIGS. 8 to 11) for switching the door lock device 20 from the unlock state to the lock state by manual user operation.

The actuator portion body 21 is a member that forms the housing of the door lock device 20 together with the meshing portion body 45. The actuator portion body 21 has a first supporting portion 211, a second supporting portion 212, a third supporting portion 213, a fourth supporting portion 214, a fifth supporting portion 215, and a sixth supporting portion 216. The first supporting portion 211 is configured to be capable of rotatably supporting the inside open lever 30. The second supporting portion 212 is configured to be capable of coaxially and rotatably supporting the inside lever 29 and the active lever 25. The third supporting portion 213 is configured to be capable of rotatably supporting the outside open lever 31. The fourth supporting portion 214 is configured to be capable of rotatably supporting the release lever 26. The fifth supporting portion 215 is configured to be capable of rotatably supporting the rotation member 23. The sixth supporting portion 216 is configured to be capable of rotatably supporting the control lever 36. It should be noted that the configurations of the first supporting portion 211 to the sixth supporting portion 216 are not particularly limited and a columnar or cylindrical shaft can be applied as illustrated in FIG. 3.

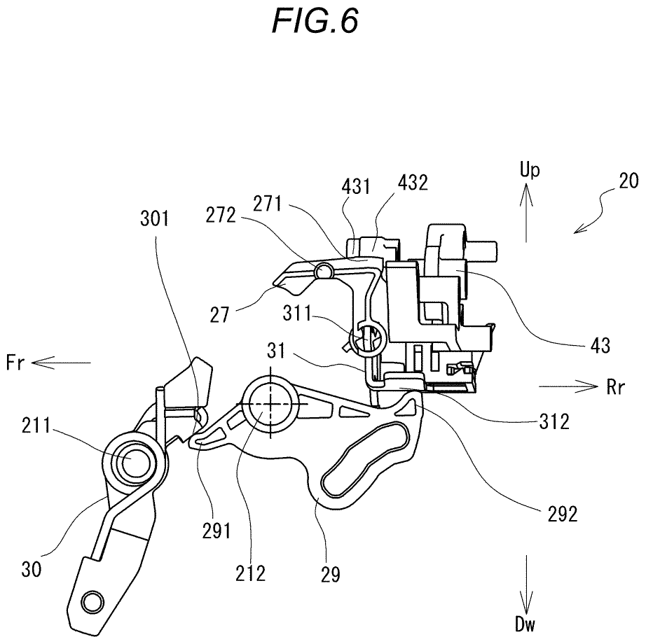

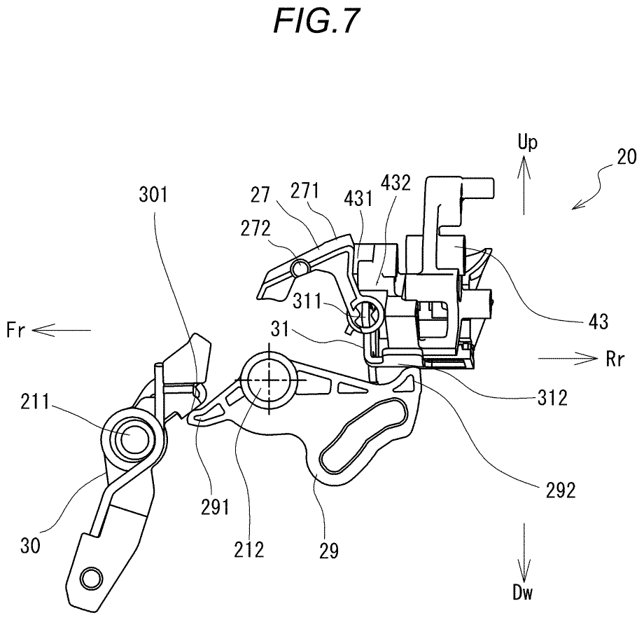

The inside open lever 30 is rotatably supported with respect to the actuator portion body 21 via the first supporting portion 211 and is capable of rotating and moving to the initial and operating positions. It should be noted that FIGS. 4 and 5 illustrate a state where the inside open lever 30 is at the initial position. In addition, the operating position of the inside open lever 30 is a position resulting from clockwise rotation from the initial position in FIGS. 4 and 5 (see FIGS. 6 and 7).

The inside open lever 30 is linked to the inside door handle 126 provided on the vehicle door 12 and is configured to move from the initial position to the operating position in conjunction with the door opening operation on the inside door handle 126. For example, the inside open lever 30 and the inside door handle 126 are connected by an operation wire (not illustrated) or the like. In addition, the inside open lever 30 is always urged toward the initial position by an inside open lever return spring (not illustrated) and the inside open lever 30 is held at the initial position by the urging force of the inside open lever return spring in a state where the door opening operation is not performed on the inside door handle 126 (that is, a state where the inside door handle 126 is at the initial position).

As illustrated in FIG. 4, the inside open lever 30 has an engagement portion 301 that can be disengageably engaged with a first engagement portion 291 of the inside lever 29. Further, when the inside open lever 30 moves from the initial position to the operating position, the engagement portion 301 of the inside open lever 30 engages with the first engagement portion 291 of the inside lever 29 and pushes the first engagement portion 291 and the inside lever 29 is moved from the initial position to the operating position.

The inside lever 29 is rotatably supported with respect to the actuator portion body 21 via the second supporting portion 212 and is capable of rotating and moving to the initial and operating positions. FIGS. 4 and 5 illustrate a state where the inside lever 29 is at the initial position. The operating position of the inside lever 29 is a position resulting from counterclockwise rotational movement from the initial position in FIGS. 4 and 5 (see FIGS. 6 and 7). The inside lever 29 has the first engagement portion 291 that can be disengageably engaged with the engagement portion 301 of the inside open lever 30 and a second engagement portion 292 that can be disengageably engaged with an engagement portion 312 of the outside open lever 31. Further, when the inside lever 29 rotationally moves from the initial position to the operating position in response to the rotational movement of the inside open lever 30, the second engagement portion 292 engages with the engagement portion 312 of the outside open lever 31 and pushes the engagement portion 312 and the outside open lever 31 is rotationally moved from the initial position to the operating position.

The outside open lever 31 is an example of the first lever member according to this disclosure. The outside open lever 31 is rotatably supported with respect to the actuator portion body 21 via the third supporting portion 213 and is capable of rotating and moving to the initial and operating positions. The outside open lever 31 has the engagement portion 312 and is configured to rotate and move from the initial position to the operating position by the engagement portion 312 engaging with the second engagement portion 292 of the inside lever 29 and being pushed. FIGS. 4 and 5 illustrate a state where the outside open lever 31 is at the initial position. The operating position of the outside open lever 31 is where the engagement portion 312 in FIGS. 4 and 5 has moved to the upper side from the initial position (see FIGS. 6 and 7). It should be noted that the rotation center line of the outside open lever 31 is perpendicular to the rotation center line of the inside lever 29 and parallel to the left-right direction in FIGS. 4 and 5.

The outside open lever 31 is linked to the outside door handle 127. For example, the outside open lever 31 is connected to the outside door handle 127 by an operation wire or the like. Further, the outside open lever 31 is configured to also rotate and move from the initial position to the operating position by the door opening operation being performed on the outside door handle 127.

It should be noted that the outside open lever 31 is always urged toward the initial position by an outside open lever return spring 32 and the outside open lever 31 is held at the initial position by the urging force of the outside open lever return spring 32 in a case where the door opening operation is not performed on the outside door handle 127 and the inside lever 29 is not at the operating position (that is, a case where the door opening operation is not performed on the inside door handle 126).

The open link 27 is an example of the link member according to this disclosure. The open link 27 is rotatably supported with respect to the outside open lever 31. For example, the open link 27 has an opening portion and the outside open lever 31 has a protrusion-shaped supporting portion 311 inserted in the opening portion of the open link 27. Further, the open link 27 is rotatably supported relative to the outside open lever 31 by the protrusion-shaped supporting portion 311 provided on the outside open lever 31. In addition, the open link 27 has a first engagement portion 271 that is configured to be disengageably engageable with a first engagement portion 431 of the lift lever 43 and a second engagement portion 272 that is configured to be engageable with an open link urging member 28.

Further, the open link 27 is capable of moving to the unlock position and the lock position by rotating relative to the outside open lever 31. Accordingly, the open link 27 is movable to the initial and operating positions with respect to the actuator portion body 21 together with the outside open lever 31 in each of the states where the open link 27 is at the unlock and lock positions. It should be noted that FIG. 4 illustrates a state where the open link 27 is at the unlock position and FIG. 5 illustrates a state where the open link 27 is at the lock position.

At the unlock position of the open link 27, the first engagement portion 271 of the open link 27 engages with the first engagement portion 431 of the lift lever 43 and the lift lever 43 can be moved to the operating position in a case where the open link 27 moves from the initial position to the operating position together with the outside open lever 31. The door lock device 20 is unlocked when the open link 27 is positioned at the unlock position. The lock position of the open link 27 is a position where the first engagement portion 271 of the open link 27 does not engage with the first engagement portion 431 of the lift lever 43 even with the open link 27 moved from the initial position to the operating position (that is, a position where the open link 27 does not move the lift lever 43 to the operating position). The door lock device 20 is locked when the open link 27 is positioned at the lock position.

The open link 27 is engaged with the open link urging member 28 via the second engagement portion 272. Applicable to the second engagement portion 272 is a protrusion-shaped configuration projecting in the direction of the rotation center line (axis) of the open link 27 from the rod-shaped part extending from the first engagement portion 271. Further, the open link 27 is linked to the active lever 25 via the open link urging member 28.

The open link urging member 28 has a function of urging the open link 27 toward either the lock position or the unlock position in accordance with the position of the active lever 25. Specifically, the open link urging member 28 urges the open link 27 toward the unlock position in a case where the active lever 25 is positioned at the unlock corresponding position and the open link urging member 28 urges the open link 27 toward the lock position in a case where the active lever 25 is positioned at the lock corresponding position.

In the present embodiment, a torsion coil spring having two arms is applied to the open link urging member 28. The two arms are substantially parallel and project in substantially the same direction. Further, the open link urging member 28 is configured to be elastically deformable such that the distance between the two arms increases. The open link urging member 28 is attached to the active lever 25 and rotatable integrally with the active lever 25 with respect to the actuator portion body 21. Further, the second engagement portion 272 of the open link 27 is disposed between the two arms. In this manner, the active lever 25 and the open link 27 are linked via the open link urging member 28 attached to the active lever 25.

The active lever 25 is rotatably supported with respect to the actuator portion body 21 by the second supporting portion 212 and can be rotationally moved to the lock corresponding position and the unlock corresponding position. FIG. 4 illustrates a state where the active lever 25 is at the unlock corresponding position, and FIG. 5 illustrates a state where the active lever 25 is at the lock corresponding position. It should be noted that the active lever 25 in the present embodiment is rotatably supported by the second supporting portion 212 so as to be coaxial with the inside lever 29. The active lever 25 is provided with a protrusion-shaped attaching portion 252, and the open link urging member 28 is attached to the attaching portion 252.

The active lever 25 is an example of the second lever member according to this disclosure. The active lever 25 is elastically urged by a moderation spring 35 toward either the lock corresponding position or the unlock corresponding position. Specifically, the active lever 25 is elastically urged toward the lock corresponding position by the moderation spring 35 in a case where the active lever 25 is positioned closer to the lock corresponding position than a predetermined position in the middle of the range in which the active lever 25 is rotationally movable and the active lever 25 is elastically urged toward the unlock corresponding position by the moderation spring 35 in a case where the active lever 25 is positioned closer to the unlock corresponding position than the predetermined position. It should be noted that the configuration of the moderation spring 35 is not particularly limited and a known existing configuration can be applied. In addition, the predetermined position is not particularly limited.

Further, the active lever 25 is configured to move from the lock corresponding position to the unlock corresponding position by the rotation member 23 (described later) rotating in a predetermined direction and rotationally move from the unlock corresponding position to the lock corresponding position by the rotation member 23 rotating in the direction opposite to the predetermined direction.

The control lever 36 is an example of the third lever member according to this disclosure. The control lever 36 is formed by a metal plate being pressed. The control lever 36 is rotatably supported with respect to the actuator portion body 21 via the sixth supporting portion 216 and can be rotationally moved to the lock corresponding position and the unlock corresponding position. More specifically, the control lever 36 is capable of swinging in a pendulum manner in the front-rear direction about the sixth supporting portion 216. FIG. 4 illustrates a state where the control lever 36 is at the unlock corresponding position, and FIG. 5 illustrates a state where the control lever 36 is at the lock corresponding position.

The active lever 25 and the control lever 36 are engaged with each other via engagement portions 251 and 361, respectively. Further, the control lever 36 is also positioned at the unlock corresponding position when the active lever 25 is positioned at the unlock corresponding position and the control lever 36 is also positioned at the lock corresponding position when the active lever 25 is positioned at the lock corresponding position. In addition, when the control lever 36 moves from the unlock corresponding position to the lock corresponding position, the active lever 25 also moves from the unlock corresponding position to the lock corresponding position. In the present embodiment, a groove (recessed portion) extending in the radial direction of the rotation center of the active lever 25 is applied to the engagement portion 251 of the active lever 25. On the other hand, a protrusion is applied to the engagement portion 361 of the control lever 36. Further, the engagement portion 361 (protrusion) of the control lever 36 enters the engagement portion 251 (groove) of the active lever 25. The active lever 25 and the control lever 36 move in conjunction with each other by the engagement portions 251 and 361 configured as described above. It should be noted that the specific configurations of the engagement portion 251 of the active lever 25 and the engagement portion 361 of the control lever 36 are not limited. In short, the active lever 25 and the control lever 36 may be engaged so as to move in conjunction with each other. The control lever 36 is configured to press the switch lever of a lock/unlock detection switch (not illustrated) when the control lever 36 is at the unlock corresponding position and not to press the switch lever of the lock/unlock detection switch when the control lever 36 is at the lock corresponding position. The lock/unlock detection switch detects that the active lever 25 is at the unlock corresponding position when the switch lever is pressed and detects that the active lever 25 is at the lock corresponding position when the switch lever is not pressed. Accordingly, the control lever 36 is a lever that operates in order to detect whether the active lever 25 is at the unlock corresponding position (that is, in the unlock state) or at the lock corresponding position (that is, in the lock state).

Further, the control lever 36 has a pressed portion 362 that can be engaged with and disengaged from a slide member 51 of the lock operation mechanism 50 (described later). The pressed portion 362 of the control lever 36 has an arm-shaped configuration that projects rearward from between the engagement portion 361 and the rotation center of the control lever 36 (sixth supporting portion 216). Further, the rear end portion of the pressed portion 362 is bent so as to extend in parallel to the vehicle width direction.

The release lever 26 is rotatably supported with respect to the actuator portion body 21 via the fourth supporting portion 214 and can be rotationally moved to the initial and operating positions. FIGS. 4 and 5 illustrate a state where the release lever 26 is at the initial position. The operating position of the release lever 26 is a position resulting from counterclockwise rotational movement from the initial position in FIGS. 4 and 5. The release lever 26 has a first engagement portion 261 that can be disengageably engaged with a second engagement portion 232 of the rotation member 23 and a second engagement portion 262 that can be disengageably engaged with a second engagement portion 432 of the lift lever 43.

The release lever 26 is configured to move from the initial position to the operating position by the rotation member 23 rotationally moving from the neutral position (described later) to the release position. When the release lever 26 moves from the initial position to the operating position, the second engagement portion 262 of the release lever 26 engages with the second engagement portion 432 of the lift lever 43 and pushes the second engagement portion 432 of the lift lever 43 and the lift lever 43 is moved from the initial position to the operating position. When the lift lever 43 moves from the initial position to the operating position in a case where the vehicle door 12 is in the closed state, the latch mechanism 40 switches from the latch state to the unlatch state and the closed state of the vehicle door 12 can be released.

The rotation member 23 is rotatably supported with respect to the actuator portion body 21 via the fifth supporting portion 215 and is configured to be rotationally movable to the neutral, unlock corresponding, lock corresponding, and release positions. The unlock corresponding position is at one end of the range in which the rotation member 23 is rotationally movable. The release position is at the other end of the range in which the rotation member 23 is rotationally movable. Each of the neutral position and the lock corresponding position is an intermediate position in the range in which the rotation member 23 is rotationally movable. It should be noted that the lock corresponding position is closer to the release position than the neutral position. In other words, the positions of the rotation member 23 are arranged in the order of the unlock corresponding position, the neutral position, the lock corresponding position, and the release position from one end of the range in which the rotation member 23 is rotatable. FIGS. 4 and 5 illustrate a state where the rotation member 23 is at the neutral position. The lock corresponding position and the release position of the rotation member 23 are positions resulting from clockwise rotational movement from the neutral position in FIGS. 4 and 5. It should be noted that the distance (rotation angle) from the neutral position to the release position exceeds the distance from the neutral position to the lock corresponding position. The unlock corresponding position of the rotation member 23 is a position resulting from counterclockwise rotational movement from the initial position in FIGS. 4 and 5.

Further, the rotation member 23 is configured to move from the neutral position to each of the unlock corresponding position, the lock corresponding position, and the release position by the drive force of the electric motor 22. For example, the rotation member 23 has a worm wheel (such as a helical gear). Further, the helical gear of the rotation member 23 meshes with a worm 222 provided on a rotary shaft 221 of the electric motor 22.

The neutral position is a position that allows the release lever 26 to be positioned at the initial position. Specifically, at the neutral position, the second engagement portion 232 provided in the rotation member 23 does not come into contact with the first engagement portion 261 of the release lever 26 positioned at the initial position. In addition, the neutral position is a position that does not come into contact with the active lever 25 positioned at the unlock corresponding position or the lock corresponding position. The rotation member 23 is always urged toward the neutral position by a rotation member return spring 24, and the rotation member 23 is held at the neutral position by the rotation member return spring 24 in a case where the electric motor 22 does not operate.

The rotation member 23 is configured to move the active lever 25 at the lock corresponding position to the unlock corresponding position side by being rotationally moved from the neutral position to the unlock corresponding position by the drive force of the electric motor 22. Further, the rotation member 23 is configured to move the active lever 25 at the unlock corresponding position to the lock corresponding position side by being rotationally moved from the neutral position to the lock corresponding position by the drive force of the electric motor 22. For example, the rotation member 23 is provided with a protrusion-shaped first engagement portion 231. Further, when the rotation member 23 is rotationally moved from the neutral position to the unlock corresponding position in a case where the active lever 25 is positioned at the lock corresponding position, the first engagement portion 231 comes into contact with and pushes the active lever 25 and the active lever 25 is moved from the lock corresponding position to the unlock corresponding position side as a result. Then, the active lever 25 is moved to the unlock corresponding position by the urging force of the moderation spring 35 when the active lever 25 moves to a predetermined intermediate position between the lock corresponding position and the unlock corresponding position. Likewise, when the rotation member 23 is rotationally moved from the neutral position to the lock corresponding position in a case where the active lever 25 is positioned at the unlock corresponding position, the first engagement portion 231 comes into contact with and pushes the active lever 25 and the active lever 25 is moved from the unlock corresponding position to the lock corresponding position side as a result. Then, the active lever 25 is moved to the lock corresponding position by the urging force of the moderation spring 35 when the active lever 25 moves to a predetermined intermediate position between the unlock corresponding position and the lock corresponding position.

Further, the rotation member 23 is configured to move the release lever 26 from the initial position to the operating position by being rotationally moved from the neutral position to the release position by the drive force of the electric motor 22 in a case where the active lever 25 is positioned at the lock corresponding position. For example, the rotation member 23 is provided with the protrusion-shaped second engagement portion 232 projecting to the side opposite to the first engagement portion 231. Further, when the rotation member 23 rotationally moves from the neutral position to the release position in a case where the active lever 25 is positioned at the lock corresponding position, the second engagement portion 232 comes into contact with and pushes the first engagement portion 261 of the release lever 26 and the release lever 26 is moved from the initial position to the operating position.

The electric motor 22 is an example of the electric drive force source according to this disclosure. The electric motor 22 is a drive force source rotating the rotation member 23 and is configured to be operated by the electric power that is supplied from an in-vehicle battery (not illustrated). It should be noted that the electric motor 22 has only to be capable of rotationally driving the rotation member 23 in both forward and reverse directions and the specific configuration of the electric motor 22 is not limited.

Here, the operation of the door lock device 20 in a case where the door opening operation is performed on the outside door handle 127 and the inside door handle 126 will be described with reference to FIGS. 6 and 7. FIG. 6 illustrates a state where the door opening operation is performed on the inside door handle 126 in a case where the door lock device 20 is in the unlock state (see FIG. 4). FIG. 7 illustrates a state where the door opening operation is performed on the inside door handle 126 in a case where the door lock device 20 is in the lock state (see FIG. 5).

When the door opening operation is performed on the inside door handle 126 in a case where the door lock device 20 is in the unlock state illustrated in FIG. 4, the movement of the inside door handle 126 is transmitted to the outside open lever 31 via the inside open lever 30 and the inside lever 29 and, as illustrated in FIG. 6, the outside open lever 31 moves from the initial position to the operating position. On the other hand, when the door opening operation is performed on the outside door handle 127, the movement of the outside door handle 127 is transmitted to the outside open lever 31 and, with the inside open lever 30 and the inside lever 29 held at the initial position, the outside open lever 31 moves from the initial position to the operating position. Then, the open link 27 moves from the initial position to the operating position together with the outside open lever 31 as illustrated in FIG. 6.

In a case where the door lock device 20 is in the unlock state, the open link 27 is at the unlock corresponding position illustrated in FIGS. 4 and 6. Accordingly, when the open link 27 moves from the initial position to the operating position together with the outside open lever 31, the first engagement portion 271 of the open link 27 engages with and pushes the first engagement portion 431 of the lift lever 43 and the lift lever 43 is moved from the initial position to the operating position. Then, by the lift lever 43 moving, the pawl 42 of the latch mechanism 40 moves from the engagement position to the non-engagement position and the latch 41 is moved to the unlatch position by the latch return spring. As a result, the latch mechanism 40 switches from the latch state to the unlatch state and the closed state of the vehicle door 12 can be released.

When the door opening operation is performed on the inside door handle 126 in a case where the door lock device 20 is in the lock state illustrated in FIG. 5, the outside open lever 31 moves from the initial position to the operating position as illustrated in FIG. 7. On the other hand, when the door opening operation is performed on the outside door handle 127, the outside open lever 31 moves from the initial position to the operating position with the inside open lever 30 and the inside lever 29 held at the initial position. Then, the open link 27 moves from the initial position to the operating position together with the outside open lever 31. However, since the open link 27 is at the lock position, the first engagement portion 271 of the open link 27 does not engage with the first engagement portion 431 of the lift lever 43 despite the movement of the open link 27 and the outside open lever 31 from the initial position to the operating position. Accordingly, the lift lever 43 is held at the initial position without being pushed by the open link 27. Accordingly, the latch mechanism 40 is held in the latch state, and thus the vehicle door 12 is held in a state where the closed state of the vehicle door 12 cannot be released.

In this manner, the closed state of the vehicle door 12 can be released by the door opening operation on the inside door handle 126 or the outside door handle 127 in a case where the door lock device 20 is in the unlock state. On the other hand, in a case where the door lock device 20 is in the lock state, the vehicle door 12 is held in a state where the closed state can be retained (state where the closed state cannot be released) despite the door opening operation on the inside door handle 126 or the outside door handle 127.

Further, the door lock device 20 is configured to be switchable from the unlock state to the lock state and from the lock state to the unlock state by the drive force of the electric motor 22. In other words, when the rotation member 23 is rotationally moved from the neutral position to the unlock corresponding position by the drive force of the electric motor 22 in a case where the door lock device 20 is in the lock state illustrated in FIG. 5, the active lever 25 moves from the lock corresponding position to the unlock corresponding position and the door lock device 20 switches to the unlock state illustrated in FIG. 4. Likewise, when the rotation member 23 is rotationally moved from the neutral position to the lock corresponding position by the drive force of the electric motor 22 in a case where the door lock device 20 is in the unlock state illustrated in FIG. 4, the active lever 25 moves from the unlock corresponding position to the lock corresponding position and the door lock device 20 switches to the lock state illustrated in FIG. 5.

It should be noted that the active lever 25 and the control lever 36 are in conjunction with each other, the control lever 36 is positioned at the unlock corresponding position when the active lever 25 is positioned at the unlock corresponding position (that is, when the door lock device 20 is in the unlock state), and the control lever 36 is positioned at the lock corresponding position when the active lever 25 is positioned at the lock corresponding position (that is, when the door lock device 20 is in the lock state).

As illustrated in FIGS. 4 and 5, the lock corresponding position of the control lever 36 is a position where the pressed portion 362 has moved to the front side as compared with the unlock corresponding position. In other words, the control lever 36 is configured to move from the unlock corresponding position to the lock corresponding position by rotating such that the pressed portion 362 rotates so as to move to the front side (by swinging in a pendulum manner).

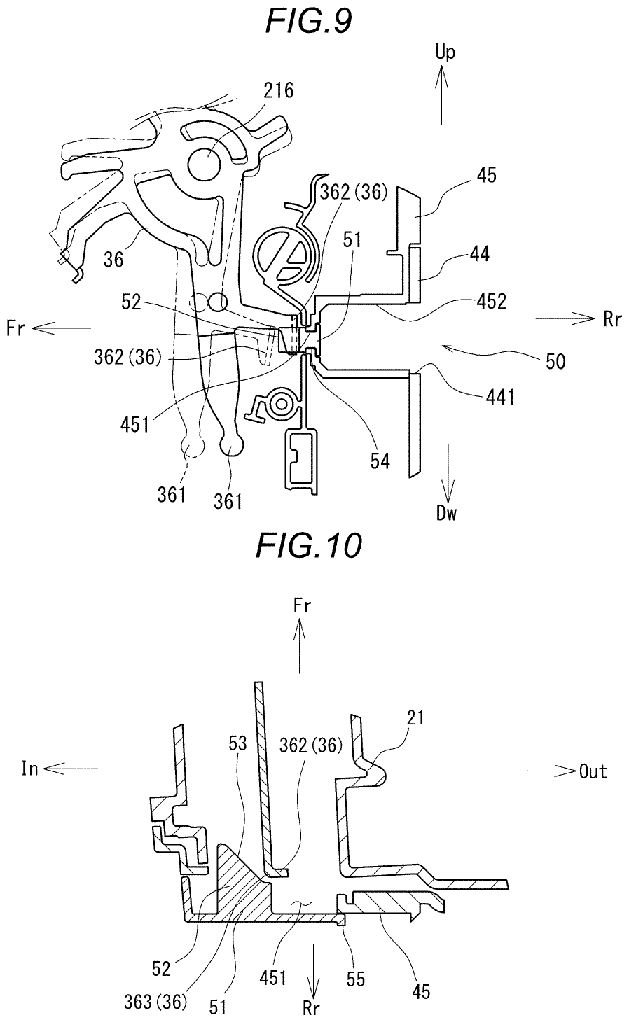

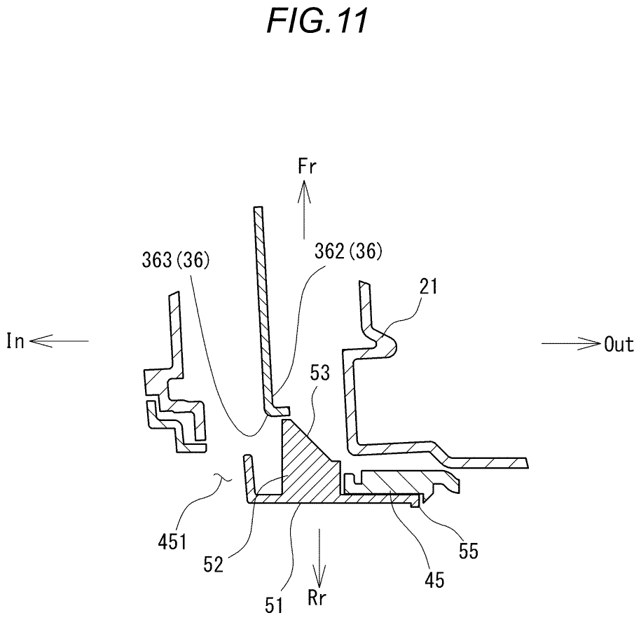

Next, the lock operation mechanism 50 for moving the control lever 36 from the unlock corresponding position to the lock corresponding position by manual user operation will be described with reference to FIGS. 8 to 11. FIG. 8 is a diagram in which a configuration example of the lock operation mechanism 50 is illustrated and the door lock device 20 is viewed from the rear side. FIG. 9 is a cross-sectional arrow view taken along line IX-IX of FIG. 8. It should be noted that the solid line in FIG. 9 indicates the control lever 36 that is positioned at the unlock corresponding position and the two-dot chain line in FIG. 9 indicates the control lever 36 that is positioned at the lock corresponding position. FIG. 10 is a cross-sectional arrow view taken along line X-X of FIG. 8 and illustrating a state where the slide member 51 is positioned at the initial position without the lock operation mechanism 50 being operated. FIG. 11 is a cross-sectional arrow view taken along line X-X of FIG. 8 and illustrating a state where the lock operation mechanism 50 is operated and the slide member 51 is positioned at the lock operation position.

As illustrated in the drawings, the lock operation mechanism 50 has an opening portion 451 provided in the meshing portion body 45 (that is, the meshing portion body 45 provided with an opening portion 451) and the slide member 51 attached to the meshing portion body 45. The opening portion 451 of the meshing portion body 45 is a through hole formed in the front-rear direction such that the inside and the outside of the door lock device 20 communicate with each other. The opening portion 451 is provided at a position accessible in a case where the vehicle door 12 is at the open position and inaccessible in a case where the vehicle door 12 is at the closed position. In the present embodiment, the opening portion 451 is provided at a position corresponding to the bottom portion (bottom surface) of a striker entry groove 452 provided in the meshing portion body 45. It should be noted that the base plate 44 is also provided with a striker entry groove 441. The striker entry grooves 441 and 452 are grooves that are long in the vehicle width direction and are configured such that the striker 101 can be inserted and removed. Further, the striker 101 enters the striker entry grooves 441 and 452 in a case where the vehicle door 12 is in the closed state. In a case where the vehicle door 12 is closed with the opening portion 451 provided in the bottom portion of the striker entry groove 452, the vehicle body 10 covers the base plate 44 and the meshing portion body 45, and thus the opening portion 451 is inaccessible. When the vehicle door 12 is open, the rear surface of the vehicle door 12 is exposed, and thus the bottom portion of the striker entry groove 452 is also exposed. Accordingly, the opening portion 451 is accessible. It should be noted that the shape of the opening portion 451 is not particularly limited and applicable examples include a long hole that is long in the left-right direction (vehicle width direction).

The slide member 51 is an example of the operation member according to this disclosure. The slide member 51 is attached to the meshing portion body 45 so as to be reciprocable in a sliding manner. For example, an engagement groove 54 extending in the left-right direction (vehicle width direction) is provided in the upper and lower surfaces of the slide member 51 and the inner peripheral edge portion of the opening portion 451 of the meshing portion body 45 enters the engagement groove 54. Accordingly, the slide member 51 is linearly reciprocable in a sliding manner in the left-right direction (long direction of the striker entry groove 452) with respect to the actuator portion body 21. In addition, the slide member 51 is positioned behind the pressed portion 362 of the control lever 36.

The slide member 51 is linearly reciprocable in a sliding manner with respect to the meshing portion body 45. Further, the slide member 51 is capable of moving to the initial and lock operation positions by moving relative to the meshing portion body 45. In a case where the lock operation mechanism 50 is not used (that is, normally), the slide member 51 is held in a state where the slide member 51 is at the initial position. The initial position is, for example, at one end of the range in which the slide member 51 is linearly reciprocable, and the lock corresponding position is, for example, at the other end of the range in which the slide member 51 is linearly reciprocable. In the present embodiment, the initial position is at the inside end of the vehicle and the lock corresponding position is at the outside end of the vehicle. However, the initial position and the lock corresponding position have only to be separated from each other in the direction allowing the sliding movement (left-right direction in the present embodiment) and are not limited to the positions at the ends of the range in which the slide member 51 is linearly reciprocable.

Further, the slide member 51 is configured to block the opening portion 451 in a case where the slide member 51 is at the initial position. For example, “block the opening portion 451” means that the opening portion 451 is invisible in the front view or the rear view (a state where the opening portion 451 does not appear and the inner portion of the door lock device 20 is invisible). Applicable to the state where “the opening portion 451 is blocked” is a state where the outer peripheral surface of the slide member 51 (contour line of slide member 51 in the rear view) is positioned outside the inner peripheral surface of the opening portion 451 (contour line of the opening portion 451 in the rear view or the front view) over the entire circumference in the front view or the rear view. When the slide member 51 is at the initial position in such a configuration, foreign matter (such as rainwater and dust) is prevented from intruding into the door lock device 20 from the outside through the opening portion 451.

It should be noted that at least a part of the slide member 51 is exposed to the outside of the meshing portion body 45 from the opening portion 451. “Exposed to the outside of the meshing portion body 45 from the opening portion 451” includes a configuration in which at least a part of the slide member 51 is closer to the inner portion side of the meshing portion body 45 than the opening portion 451 and yet accessible through the opening portion 451 as well as a configuration in which at least a part of the slide member 51 is positioned outside the opening portion 451. Illustrated in the present embodiment is a configuration in which the rear surface of the slide member 51 and a protruding portion 55 (described later) are exposed from the opening portion 451 of the meshing portion body 45. In short, at least a part of the slide member 51 may be exposed from the opening portion 451 to the outside of the meshing portion body 45 such that access (operation) is possible from the outside of the door lock device 20.

A pressing portion 52 that can be engaged with and disengaged from the pressed portion 362 of the control lever 36 is provided on the front side of the slide member 51 (part positioned in the door lock device 20). The pressing portion 52 is a part projecting toward the front side. Provided on the front end side of the pressing portion 52 is a pressing surface 53 facing diagonally forward and inclined with respect to the direction in which the slide member 51 is linearly reciprocable and the front-rear direction (that is, the direction of movement of the pressed portion 362 of the control lever 36 in the top view in a case where the control lever 36 rotates) in the top view. Further, the pressing portion 52 is configured to be positioned at a position that allows the control lever 36 to be positioned at the unlock corresponding position (position of no interference with the control lever 36 positioned at the unlock corresponding position) in a case where the slide member 51 is positioned at the initial position. For example, the pressing portion 52 of the slide member 51 is at a position of no contact with the engagement portion 361 of the control lever 36 positioned at the unlock corresponding position.

In addition, the rear surface of the slide member 51 (that is, a part exposed to the outside of the meshing portion body 45) is provided with the protruding portion 55 projecting toward the outside of the meshing portion body 45. It should be noted that the specific shape of the protruding portion 55 is not particularly limited and the protruding portion 55 is preferably a configuration allowing a tool such as a car key and a screwdriver to be hooked. The operation of the slide member 51 is facilitated by the slide member 51 being provided with the protruding portion 55.

Further, when the slide member 51 moves from the initial position to the lock operation position by manual user operation, the pressing surface 53 of the pressing portion 52 pushes the pressed portion 362 of the control lever 36 positioned at the unlock corresponding position. As described above, the pressing surface 53 faces diagonally forward. Accordingly, a diagonally forward force is applied to the pressed portion 362 of the control lever 36 when the slide member 51 moves from the initial position toward the lock operation position and the pressing surface 53 of the pressing portion 52 pushes the pressed portion 362 of the slide member 51. Accordingly, the pressed portion 362 of the control lever 36 is moved to the front side by the front-rear-direction component force of the force and the control lever 36 moves from the unlock corresponding position to the lock corresponding position. Then, in conjunction with the movement of the control lever 36 from the unlock corresponding position to the lock corresponding position, the active lever 25 also moves from the unlock corresponding position to the lock corresponding position. Accordingly, the door lock device 20 switches from the unlock state to the lock state.

It should be noted that the pressed portion 362 of the control lever 36 in a case where the control lever 36 is positioned at the unlock corresponding position is positioned inside the movement trajectory of the pressing surface 53 of the slide member 51 in order to realize such operation. Further, the pressed portion 362 of the control lever 36 is positioned outside and in front of the movement trajectory of the pressing surface 53 of the slide member 51 in a case where the control lever 36 is positioned at the lock corresponding position. In addition, the pressed portion 362 of the control lever 36 is configured to be closer to the lock operation position side of the slide member 51 than the pressing surface 53 in a case where the slide member 51 is at the initial position. It should be noted that the slide member 51 in the present embodiment is configured to move from the initial position to the lock operation position by moving from the outside in the vehicle width direction to the inside in the vehicle width direction. Applied to the pressing surface 53 in this case is an inclined surface where the outside end portion in the vehicle width direction is positioned in front of the inside end portion in the vehicle width direction in the vertical view.

In addition, as described above, the control lever 36 is linked to the active lever 25 and the active lever 25 is urged toward the unlock corresponding position or the lock corresponding position by the moderation spring 35. Accordingly, after the slide member 51 moves the control lever 36 to a predetermined intermediate position between the unlock corresponding position and the lock corresponding position, it is moved to the lock corresponding position together with the active lever 25 by the urging force of the moderation spring 35. Accordingly, the slide member 51 does not have to be configured to move the control lever 36 to the lock corresponding position and has only to be configured to be capable of moving the control lever 36 to a predetermined intermediate position between the unlock corresponding position and the lock corresponding position (position where the direction of the urging force of the moderation spring 35 changes toward the lock corresponding position).

In addition, as illustrated in FIGS. 10 and 11, the pressed portion 362 of the control lever 36 has an arm-shaped configuration extending rearward and the rear end portion of the pressed portion 362 is bent so as to be parallel to the vehicle width direction. Accordingly, the outer peripheral surface of the bent part (curved portion 363) is a curved surface having a predetermined radius of curvature. Further, the pressing surface 53 is configured to come into contact with the curved portion 363 in a case where the slide member 51 has moved from the initial position to the lock operation position. Accordingly, the slide member 51 is smoothly movable when the slide member 51 moves from the initial position to the lock operation position and pushes the pressed portion 362. In other words, in a configuration in which the pressing surface 53 of the slide member 51 comes into contact with the tip corner portion of the pressed portion 362, the corner portion may be hooked by the pressing surface 53 and the slide member 51 may not move smoothly. On the other hand, according to the present embodiment, it is possible to prevent the pressed portion 362 from being hooked by the pressing surface 53 since the curved portion 363 comes into contact with the pressing surface 53.

According to the lock operation mechanism 50, the door lock device 20 can be manually switched from the unlock state to the lock state even in a case where the electric motor 22 is inoperable. In other words, the unlock-to-lock switching by means of the drive force of the electric motor 22 is impossible when the electric motor 22 is inoperable due to a decrease in in-vehicle battery charge amount (that is, in the event of electric power loss). Further, since the vehicle door 12 has neither a lock knob nor a key cylinder, it is impossible to switch the door lock device 20 from the unlock state to the lock state by lock knob and key cylinder operation. However, in the present embodiment, it is possible to switch the door lock device 20 from the unlock state to the lock state by manually sliding the slide member 51 of the lock operation mechanism 50.

It should be noted that the slide member 51 is preferably configured to be urged toward the initial position by an urging member such as a spring. After the lock operation is performed in such a configuration, the slide member 51 automatically returns to the initial position by the urging force of the urging member. In addition, with such a configuration, it is possible to prevent the slide member 51 from moving from the initial position to the lock operation position due to inertia, vibration, or the like. Accordingly, in a case where the lock operation is not performed, the opening portion 451 is always held in a blocked state and foreign matter intrusion is prevented. It should be noted that the configuration of the urging member is not particularly limited. Various springs such as torsion coil and leaf springs can be applied to the urging member.

In addition, the slide member 51 and the meshing portion body 45 may have a positioning mechanism for positioning the slide member at the initial position. For example, a protrusion is provided on one of the slide member 51 and the meshing portion body 45 with a recessed portion provided in the other. Further, the protrusion is configured to enter the recessed portion in a case where the slide member 51 is positioned at the initial position. With such a configuration, it is possible to hold the slide member 51 at the initial position in a case where the lock operation is not performed.

As described above, according to the embodiment disclosed here, it is possible to switch the door lock device 20 from the unlock state to the lock state by moving the slide member 51 from the initial position to the lock corresponding position in a case where the electric motor 22 is inoperable due to a decrease in in-vehicle battery charge amount. Accordingly, it is possible to reliably switch the door lock device 20 from the unlock state to the lock state even with the vehicle door 12 lacking a lock knob.

The slide member 51 is attached so as to be movable in a sliding manner. Accordingly, it is possible to block the opening portion 451 at all times and prevent foreign matter intrusion in a case where no unlock operation is performed. Further, the slide member 51 is attached to the meshing portion body 45 at all times, does not have to be removed during operation, and thus is free from the risk of loss.

A vehicular door lock device (20) according to an aspect of this disclosure includes: a latch mechanism (40) configured to be switchable between a latch state where a vehicle door (12) is holdable in a closed state and an unlatch state where the closed state of the vehicle door is releasable by moving from an initial position to an operating position; a first lever member (outside open lever (31)) configured to be moved to an operating position when door opening operation is performed on a door handle (inside door handle (126) or outside door handle (127)) provided on the vehicle door (12); a second lever member (active lever (25)) configured to be moved to an unlock corresponding position and a lock corresponding position by a drive force of an electric drive force source (electric motor (22)); a link member (open link (27)) movable to an unlock position where the latch mechanism (40) is switchable to the unlatch state when the first lever member (outside open lever (31)) is at the operating position and a lock position where the latch mechanism (40) is not switchable to the unlatch state even when the first lever member (outside open lever (31)) is at the operating position and configured to be positioned at the unlock position when the second lever member (active lever (25)) is positioned at the unlock corresponding position and to be positioned at the lock position when the second lever member (active lever (25)) is positioned at the unlock corresponding position; and an operation member (slide member (51)) movable to an initial position and an operation position and configured to move the second lever member (active lever (25)) from the unlock corresponding position to the lock corresponding position by moving from the initial position to the operation position.

Further, the operation member (slide member (51)) is attached to a housing (meshing portion body (45)), in which the latch mechanism (40) is assembled and an opening portion (451) is provided, so as to be movable relative to the housing (meshing portion body (45)), at least a part of the operation member (slide member (51)) is exposed to an outside from the opening portion (451), and the operation member (slide member (51)) blocks the opening portion (451) when the operation member (slide member (51)) is at the initial position.

When this disclosure is configured as described above, it is possible to switch the door lock device (20) from the unlock state (state where the latch mechanism (40) is switchable to the unlatch state) to the lock state (state where the latch mechanism (40) is not switchable to the unlatch state) by moving the operation member (slide member (51)) from the initial position to the operation position even in a case where the electric drive force source (electric motor (22)) does not operate, examples of which include a case where the charge amount of an in-vehicle battery has decreased. Further, the operation member (slide member 51) at the initial position blocks the opening portion (451) provided in the housing (meshing portion body (45)), and thus foreign matter (such as rainwater and dust) is prevented from entering the vehicular door lock device (20) through the opening portion (451).

The vehicular door lock device (20) may further include a third lever member (control lever (36)) movable to an unlock corresponding position and a lock corresponding position and linked to the second lever member (active lever (25)) such that the second lever member (active lever (25)) is also positioned at the unlock corresponding position when the third lever member (control lever (36)) is positioned at the unlock corresponding position and the second lever member (active lever (25)) is also positioned at the lock corresponding position when the third lever member (control lever (36)) is positioned at the lock corresponding position. The operation member (slide member (51)) may be configured to push the third lever member (control lever (36)) and move the third lever member (control lever (36)) from the unlock corresponding position to the lock corresponding position by moving from the initial position to the operation position.

The third lever member (control lever (36)) may be swingable in a pendulum manner in a front-rear direction, and the lock corresponding position of the third lever member (control lever (36)) may be in front of the unlock corresponding position of the third lever member (control lever (36)). The operation member (slide member (51)) may be configured to be movable to the initial position and the operation position by moving in a vehicle width direction and have a pressing surface (53) as an inclined surface inclined in the vehicle width direction and the front-rear direction, and the operation member (slide member (51)) may be configured such that the pressing surface (53) pushes the third lever member (control lever (36)) at the unlock corresponding position toward a front side as the lock corresponding position side as the operation member (slide member (51)) moves from the initial position to the operation position.

The operation member (slide member (51)) may be provided with a protruding portion (55) projecting toward an outside of the housing (meshing portion body (45)).

With such a configuration, it is possible to move the operation member (slide member (51)) from the initial position to the operation position by hooking a tool or the like (such as a car key and a screwdriver) on the protruding portion (55). Accordingly, the operation of the operation member (slide member (51)) is facilitated.

The housing may be a meshing portion body (45) provided on a vehicle body (10) and having a striker entry groove (452) where a striker (101) meshing with the latch mechanism (40) enters when the latch mechanism (40) is in the latch state. The opening portion (451) may be formed in a bottom portion of the striker entry groove (452).

In addition, the vehicular door lock device (20) may include an urging member urging the operation member (slide member (51)) toward the initial position.

By the urging member being provided, the operation member (slide member (51)) is prevented from moving from the initial position to the lock operation position due to inertia or the like.

This disclosure is not limited to the embodiment disclosed here. This disclosure can be modified without departing from the spirit of this disclosure, and the modifications are also included in the technical scope of the present invention.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicular door lock device comprising:
a latch mechanism configured to be switchable between a latch state where a vehicle door is holdable in a closed state and an unlatch state where the closed state of the vehicle door is releasable by moving from an initial position to an operating position;
a first lever member configured to be moved to an operating position when door opening operation is performed on a door handle provided on the vehicle door;
a second lever member configured to be moved to an unlock corresponding position and a lock corresponding position by a drive force of an electric drive force source;
a link member movable to an unlock position where the latch mechanism is switchable to the unlatch state when the first lever member is at the operating position and a lock position where the latch mechanism is not switchable to the unlatch state even when the first lever member is at the operating position and configured to be positioned at the unlock position when the second lever member is positioned at the unlock corresponding position and to be positioned at the lock position when the second lever member is positioned at the unlock corresponding position; and
an operation member movable to an initial position and an operation position and configured to move the second lever member from the unlock corresponding position to the lock corresponding position by moving from the initial position to the operation position, wherein
the operation member is attached to a housing, in which the latch mechanism is assembled and an opening portion is provided, so as to be movable relative to the housing, at least a part of the operation member is exposed to an outside from the opening portion, and the operation member blocks the opening portion when the operation member is at the initial position.

2. The vehicular door lock device according to claim 1, further comprising
a third lever member movable to an unlock corresponding position and a lock corresponding position and linked to the second lever member such that the second lever member is also positioned at the unlock corresponding position when the third lever member is positioned at the unlock corresponding position and the second lever member is also positioned at the lock corresponding position when the third lever member is positioned at the lock corresponding position, wherein
the operation member is configured to push the third lever member and move the third lever member from the unlock corresponding position to the lock corresponding position by moving from the initial position to the operation position.

3. The vehicular door lock device according to claim 2, wherein
the third lever member is swingable in a pendulum manner in a front-rear direction, and the lock corresponding position of the third lever member is in front of the unlock corresponding position of the third lever member, and
the operation member is configured to be movable to the initial position and the operation position by moving in a vehicle width direction and has a pressing surface as an inclined surface inclined in the vehicle width direction and the front-rear direction, and the operation member is configured such that the inclined surface pushes the third lever member at the unlock corresponding position toward a front side as the lock corresponding position side as the operation member moves from the initial position to the operation position.

4. The vehicular door lock device according to claim 1, wherein
the operation member is provided with a protruding portion projecting toward an outside of the housing.

5. The vehicular door lock device according to claim 1, wherein
the housing is a meshing portion body provided on a vehicle body and having a striker entry groove where a striker meshing with the latch mechanism enters when the latch mechanism is in the latch state, and
the opening portion is formed in a bottom portion of the striker entry groove.

6. The vehicular door lock device according to claim 1, further comprising
an urging member urging the operation member toward the initial position.
